(19) United States
(12) Patent Application Publication
(10) Pub. No.: US 2019/0163847 A1
(43) Pub. Date: May 30, 2019

(54) METHOD, APPARATUS, AND SYSTEM FOR PREDICTING SPREAD OF DISASTER USING SCENARIO

(71) Applicant: ELECTRONICS AND TELECOMMUNICATIONS RESEARCH INSTITUTE, Daejeon (KR)

(72) Inventors: Seung Hee OH, Daejeon (KR); Seong Hyun KIM, Daejeon (KR); Jin SON, Daejeon (KR); Yong Tae LEE, Daejeon (KR); Woo Sug JUNG, Daejeon (KR)

(21) Appl. No.: 16/126,876

(22) Filed: Sep. 10, 2018

(30) Foreign Application Priority Data
Nov. 24, 2017 (KR) 10-2017-0158740
Jul. 27, 2018 (KR) 10-2018-0087946

(51) Int. Cl. G06F 17/50; G06F 17/30; G01W 1/10

(52) U.S. Cl. CPC G06F 17/5009; G01W 1/10; G06F 17/30312; G06F 17/30309

(57) ABSTRACT

Disclosed are a method, apparatus, and system for predicting a spread of a disaster with respect to multiple disasters. According to the present disclosure, the method includes: receiving disaster-related information; generating a disaster-connection scenario by applying a regional characteristic and connection between disasters to the disaster-related information; performing disaster modeling on each of the disasters that make up the disaster-connection scenario; and predicting a spread of the multiple disasters by integrating results of the disaster modeling. According to an embodiment of the present disclosure, it is possible that a spread of multiple disasters originated from a single disaster situation is predicted and provided in real time. Also, according to an embodiment of the present disclosure, it is possible that a multi-disaster situation predicted in real time is checked and preparation for natural disasters and multiple disasters in advance is performed.

### CROSS REFERENCE TO RELATED APPLICATION

The present application claims priority to Korean Patent Applications No. 10-2017-0158740, filed Nov. 24, 2017, and No. 10-2018-0087946, filed Jul. 27, 2018, the entire contents of which are incorporated herein for all purposes by this reference.

### BACKGROUND OF THE INVENTION

### Field of the Invention

The present disclosure relates generally to an apparatus and method of predicting a spread of a disaster with respect to multiple disasters. Also, the present disclosure relates generally to a system for predicting a spread of a disaster with respect to multiple disasters.

### Description of the Related Art

National disasters that occur at home and abroad have become more complex, larger, and diverse. Therefore, preparing for a disaster on the basis of information on a past disaster history has a limit to predict and prepare for future disasters. As a representative example, in the case of the localized heavy rainfall in Cheongju, Republic of Korea in July 2017, a heavy rain prevention facility was built on the basis of the frequency of 50 years, but due to a heavy rain of 100-years frequency, various types of damage occurred such as floods, landslides, subsidence, and loss of a railroad and a communication network.

Also, climate change and the complexity and congestion of cities have led to an increase in connection between disasters when disasters occur, and the number of disasters that occur in a consecutive manner has increased. Particularly, in recent years, the possibility of occurrence of a major disaster has increased due to the activation of the earthquake zone, and thus there is a growing need and the necessity at the national level to predict and respond to major disasters.

In this regard, there is a limit the local government or nation predicts and responses disasters assuming that all natural disasters and social disasters possibly occur, because types and the number of disasters are so diverse. Thus, disaster prediction based on a scenario with probability and preparations are required, and importance and necessity of a system for predicting a spread of disaster have increased.

That is, conventionally, prediction has been performed with respect to single disasters such as a typhoon, a heavy rain, an earthquake, and the like, but there has been no method and system for predicting connection between multiple natural disasters and predicting a social disaster caused by the natural disaster.

Particularly, due to urbanization and dense population, a disaster originated from a natural disaster is connected to other natural disasters and social disasters in a consecutive manner, which results in a rapid increase in economic and social damage. Therefore, as steps for preventing a major disaster, there are six steps: prediction, prevention, preparation, response, recovery, and assessment of the disaster. Accordingly, importance of prediction has increased, and thus a real-time system used in the disaster prediction step is required.

Also, individual natural disaster and social disaster modeling calculates the result values according to the grid size and the type of input data, which takes at least a few hours and at most one week or more (for example, Deft3D used in tsunami and storm surge simulation usually takes three days). Therefore, a system for predicting the spread of disaster that reduces the modeling processing time is required.

The foregoing is intended merely to aid in the understanding of the background of the present disclosure, and is not intended to mean that the present disclosure falls within the purview of the related art that is already known to those skilled in the art.

### SUMMARY OF THE INVENTION

Accordingly, the present disclosure has been made keeping in mind the above problems occurring in the related art, and the present disclosure is intended to propose an apparatus and method of predicting a spread of a disaster with respect to multiple disasters in real time. Also, the present disclosure is intended to propose a system for predicting a spread of a disaster with respect to multiple disasters in real time.

Also, the present disclosure is intended to propose a method, apparatus, and system for predicting a spread of a disaster on the basis of a scenario with probability originated from a single natural disaster and connected to other disasters.

Also, the present disclosure is intended to propose a method, apparatus, and system for predicting a spread of a disaster by checking disasters (including an individual natural disaster, an individual social disaster, and multiple disasters) in advance and predicting disasters to be managed at the national level.

Also, the present disclosure is intended to propose a method, apparatus, and system for predicting a spread of a disaster by generating a disaster scenario having probability with application of a regional characteristic (facilities, population, industrial structure, a type of participation in agriculture and livestock industry, and the like) and a past disaster history, and by predicting the spread of disasters according to the regional characteristics, whereby utilization at disaster preparation and disaster response steps is possible.

Also, the present disclosure is intended to propose a system for predicting a spread of a disaster, the system including a function of generating a scenario wherein a single natural disaster is connected to another natural disaster and social disaster; and to propose a technique of managing a result of modeling for efficiently using the system for predicting the spread of the disaster.

Also, the present disclosure is intended to propose a method, apparatus, and system for predicting a spread of a disaster, which manage a history of the result of disaster modeling so that modeling of the same environment performed previously is not performed again by a different disaster-connection scenario through the technique of managing the result of modeling, whereby the time for performing modeling is reduced through the stored history of the result of disaster modeling.

Other objects and advantages of the present disclosure will be understood from the following descriptions and become apparent by the embodiments of the present disclosure. In addition, it is understood that the objects and advantages of the present disclosure may be implemented by components defined in the appended claims or their combinations.

In order to achieve the above object, according to the present disclosure, there is provided a method of predicting a spread of a disaster using a scenario, the method including: receiving disaster-related information; generating a disaster-connection scenario by applying a regional characteristic and connection between disasters to the disaster-related information; performing disaster modeling on each of the disasters that make up the disaster-connection scenario; and predicting a spread of the multiple disasters by integrating results of the disaster modeling. Also, the generating of the disaster-connection scenario may include checking a past disaster case history and a past disaster scenario history.

Also, the performing of the disaster modeling may include: performing natural disaster modeling; and performing social disaster modeling.

Also, the performing of the disaster modeling may include checking a past history of performing each disaster modeling.

Also, the method of predicting the spread of the disaster using the scenario may further include storing a result of the generated disaster-connection scenario, a result of performing the disaster modeling, and a result of performing integrated multi-disaster modeling.

Also, the method of predicting the spread of the disaster using the scenario may further include providing a result of predicting the spread of the multiple disasters as a visual screen.

Also, according to the present disclosure, there is provided an apparatus for predicting a spread of a disaster using a scenario, the apparatus including: an information receiving unit receiving disaster-related information from a user; a scenario generating unit generating a disaster-connection scenario by applying a regional characteristic and connection between disasters to the received disaster-related information; an integrated multi-disaster modeling unit performing disaster modeling on each of the disasters that make up the disaster-connection scenario and predicting a spread of the multiple disasters by integrating results of the disaster modeling; and a storage unit storing a result of predicting the spread of the multiple disasters.

Also, the apparatus for predicting the spread of the disaster using the scenario may further include a display unit providing the result of predicting the spread of the multiple disasters as a visual screen.

Also, the apparatus for predicting the spread of the disaster using the scenario may further include: a scenario history database (DB) storing a result of the disaster-connection scenario; an individual disaster history database (DB) storing a history for each disaster; and a disaster spread prediction result database (DB) the result of predicting the spread of the multiple disasters.

Also, the storage unit may include a region coefficient database (DB) storing the regional characteristic.

Also, the information receiving unit may include: a user interface (UI) receiving the disaster-related information from the user or may include a wireless communication unit receiving the disaster-related information from a remote user.

Also, according to the present disclosure, there is provided a system for predicting a spread of a disaster using a scenario, the system including: a user terminal providing disaster-related information via a wired/wireless communication unit; and a server for predicting multiple disasters, the server being configured to: generate a disaster-connection scenario by applying a regional characteristic and connection between the disasters to the disaster-related information; perform disaster modeling on each of the disasters that make up the disaster-connection scenario; predict a spread of the multiple disasters by integrating results of the disaster modeling; and transmit a result of prediction to the user terminal.

Also, in the system for predicting the spread of the disaster using the scenario, the server for predicting the multiple disasters may include a database therein, the database storing the disaster-connection scenario and the results of the disaster modeling that are generated by the server for predicting the multiple disasters.

Also, in the system for predicting the spread of the disaster using the scenario, a database, which stores the disaster-connection scenario and the results of the disaster modeling that are generated by the server for predicting the multiple disasters, may be provided in an external organization that is capable of wired/wireless communication with the server for predicting the multiple disasters.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a diagram illustrating configuration of an apparatus for predicting a spread of multiple disasters according to the present disclosure;

FIG. 2 is a flowchart illustrating an example of a method of predicting a spread of multiple disasters according to the present disclosure;

FIGS. 3 and 4 are flowcharts illustrating examples of automatically generating a connection scenario in the method of predicting the spread of multiple disasters according to the present disclosure;

FIGS. 5A and 5B are diagrams illustrating examples of connection scenarios of spread of multiple disasters, which are generated according to the present disclosure;

FIG. 6 is a flowchart illustrating an example of performing individual-disaster modeling in the method of predicting the spread of multiple disasters according to the present disclosure;

FIG. 7 is a flowchart illustrating an example of a method of predicting a spread of multiple disasters by using a past scenario history and/or a past individual disaster history according to the present disclosure;

FIGS. 8 and 9 are diagrams illustrating examples of a method of predicting a spread of multiple disasters by using a process of checking a past scenario history and an individual disaster history and of updating databases according to the present disclosure; and

FIG. 10 is a diagram illustrating another use example of a system for predicting a spread of multiple disasters according to the present disclosure.

### DETAILED DESCRIPTION OF THE INVENTION

Hereinbelow, exemplary embodiments of the present disclosure will be described in detail with reference to the accompanying drawings such that the disclosure can be easily embodied by those skilled in the art to which this disclosure belongs. However, the present disclosure may be embodied in various different foams and should not be limited to the embodiments set forth herein.

In the following description, if it is decided that the detailed description of known function or configuration related to the disclosure makes the subject matter of the disclosure unclear, the detailed description is omitted. Also, portions that are not related to the present disclosure are omitted in the drawings, and like reference numerals designate like elements.

In the present disclosure, components that are distinguished from each other to clearly describe each feature do not necessarily denote that the components are separated. That is, a plurality of components may be integrated into one hardware or software unit, or one component may be distributed into a plurality of hardware or software units. Accordingly, even if not mentioned, the integrated or distributed embodiments are included in the scope of the present disclosure.

In the present disclosure, components described in various embodiments do not denote essential components, and some of the components may be optional. Accordingly, an embodiment that includes a subset of components described in another embodiment is included in the scope of the present disclosure. Also, an embodiment that includes the components which are described in the various embodiments and additional other components is included in the scope of the present disclosure.

Hereinafter, the embodiments of the present disclosure will be described with reference to the accompanying drawings.

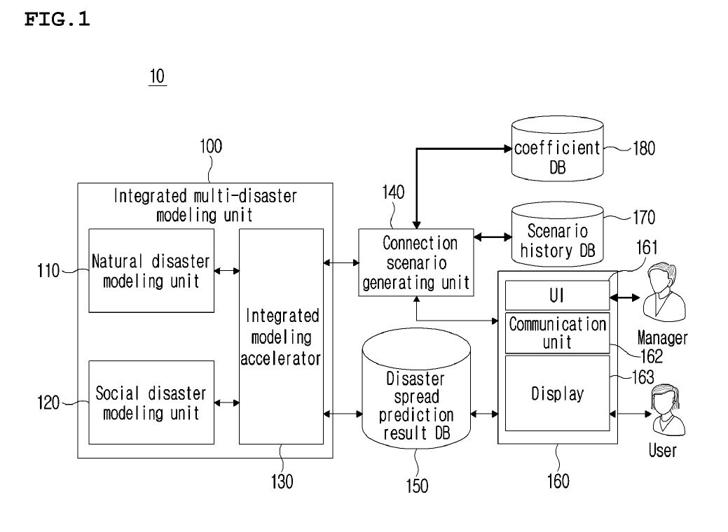

FIG. 1 is a diagram illustrating configuration of an apparatus 10 for predicting a spread of multiple disasters according to the present disclosure.

Referring to FIG. 1, according to the present disclosure, the apparatus 10 for predicting the spread of multiple disasters includes: an integrated multi-disaster modeling unit 100 having a natural disaster modeling unit 110, a social disaster modeling unit 120, and an integrated modeling accelerator 130; and a connection scenario generating unit 140 generating a multi-disaster scenario. In this regard, although the integrated multi-disaster modeling unit 100 and the connection scenario generating unit 140 are separated from each other for convenience of description, it is possible that the units are implemented in such a manner as to be programmed and operated within a single processor in practice. Also, although the natural disaster modeling unit 110, the social disaster modeling unit 120, and the integrated modeling accelerator 130 in the integrated multi-disaster modeling unit 100 have been described separately for convenience of description, it is possible in practice that these are implemented in such a manner as to be programmed and operated within a single processor.

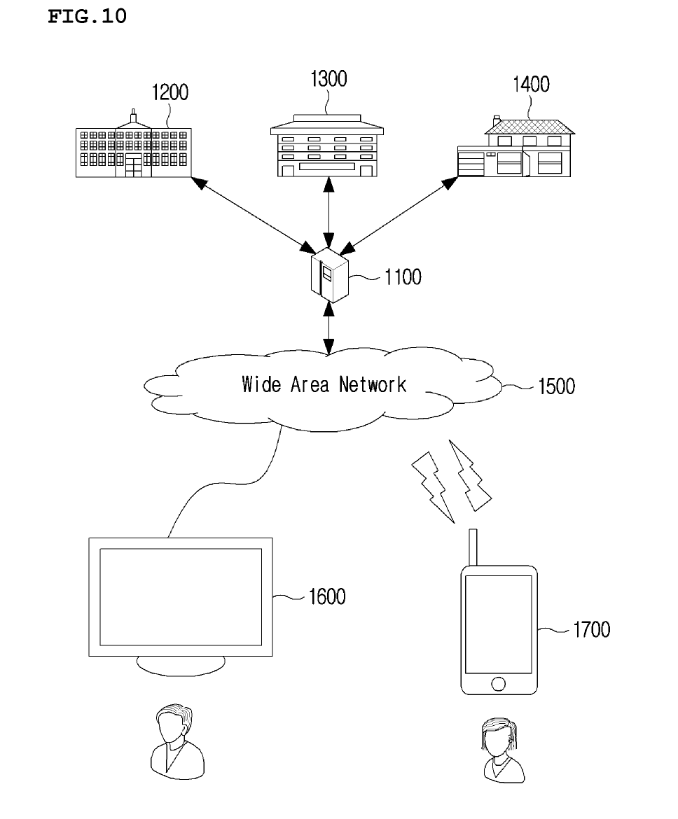

Also, according to the present disclosure, the apparatus 10 for predicting the spread of multiple disasters includes a visualization and external linkage unit 160 having: a user interface (UI) 161; a communication unit 162 capable of wired/wireless communication with an external user; and a display unit 163 providing a visual prediction result and relevant information. In this regard, the user interface 161 and the communication unit 162 may be referred to as “an information receiving unit” receiving disaster-related information from the user. For example, according to the present disclosure, when the user directly utilizes, in the same physical space, the apparatus 10 for predicting the spread of multiple disasters, information is input via the user interface 161. When the user remotely utilizes in a separated space the apparatus, disaster information is transmitted or received through wired/wireless communications between a user terminal (for example, 1600 and 1700 in FIG. 10) and the communication unit 162. Also, specifically, the user interface 161 may be configured as a graphical user interface (GUI).

Also, according to the present disclosure, the apparatus 10 for predicting the spread of multiple disasters includes a storage unit having: a disaster spread prediction result database (DB) 150 storing a history of each disaster and the result of predicting multiple disasters; a scenario history database (DB) 170 storing a result of a disaster-connection scenario; and a region coefficient database (DB) 180 storing regional characteristics. However, although the databases 150, 170, and 180 of the storage unit are separately shown in FIG. 1 for convenience of description, it does not mean that the databases are necessarily located in physically separated spaces, and the databases may be configured in divided spaces within a single database together.

In this regard, considering independence of each constituent in the apparatus 10 for predicting the spread of multiple disasters, the apparatus 10 for predicting the spread of multiple disasters shown in FIG. 1 may be configured as “a system for predicting a spread of multiple disasters”. For example, it is possible that the constituents in the apparatus 10 for predicting the spread of multiple disasters are independent individual systems, which make up the system 10 for predicting the spread of multiple disasters, and are individually configured at physically separated remote places. This will be described in detail with reference to FIG. 10.

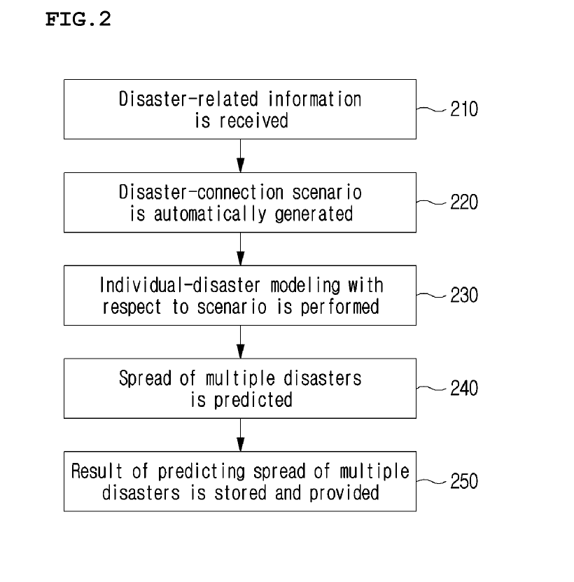

FIG. 2 is a flowchart illustrating an example of a method of predicting a spread of multiple disasters according to the present disclosure. Hereinafter, description will be made with reference to the configuration shown in FIG. 1 and the flowchart shown in FIG. 2.

In the present disclosure, a user/manager who utilizes the apparatus or system for predicting the spread of multiple disasters may be divided into a manager and a user according to the user authority. The user/manager accesses the system for predicting the spread of the disaster via the UI 161, for example, the graphical user interface (GUI) in the visualization and external linkage unit 160 to generate the scenario and receive the result of modeling.

First, disaster-related information which is related to the region selected by the user/manager, the type of disaster, and the degree of disaster is received at step 210.

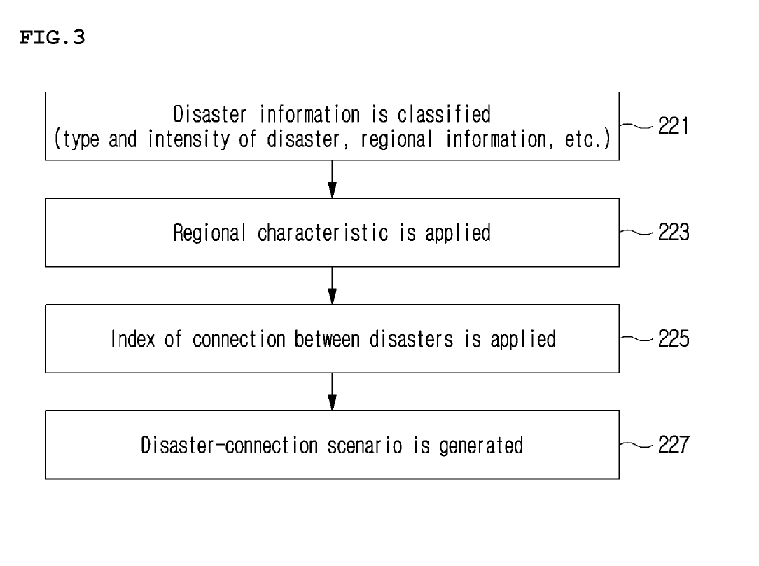

According to the received disaster-related information, the connection scenario generating unit 140 automatically generates a disaster scenario associated with the received disaster-related information at step 220. However, rather than the automatic generation, the manager/user may manually generate a part of the scenario. For example, after classifying the disaster-related information according to a particular classification criterion, the connection scenario generating unit 140 may generate the disaster-connection scenario in stages by receiving phased information input by the manager/user. The generating of the disaster-connection scenario at step 220 will be described in detail with reference to FIGS. 3 to 5A and 5B.

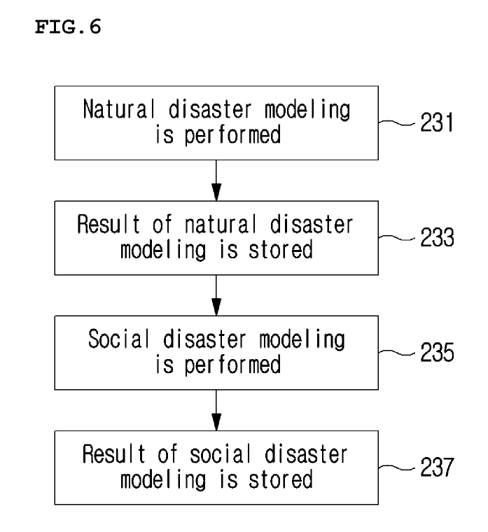

When the disaster-connection scenario is generated, individual-disaster modeling is performed on the basis of the relevant scenario at step 230. At the performing of the individual-disaster modeling at step 230, natural disaster modeling and social disaster modeling are performed by the natural disaster modeling unit 110 and the social disaster modeling unit 120 shown in FIG. 1, respectively. The performing of the individual-disaster modeling at step 230 will be described in detail with reference to FIG. 6.

When the individual-disaster modeling is completed, the integrated modeling accelerator 130 performs prediction of the spread of multiple disasters in which the results of the individual-disaster modeling are integrated at step 240. In this regard, the performing of the individual-disaster modeling at step 230 and the prediction of the spread of multiple disasters at step 240 may be integrally implemented by the integrated multi-disaster modeling unit 100. Alternatively, in FIG. 1, the natural disaster modeling unit 110 and the social disaster modeling unit 120 may be directly integrated into a physical system according to the characteristics, or may be configured in the form of exchanging information through an interface connection as being present outside.

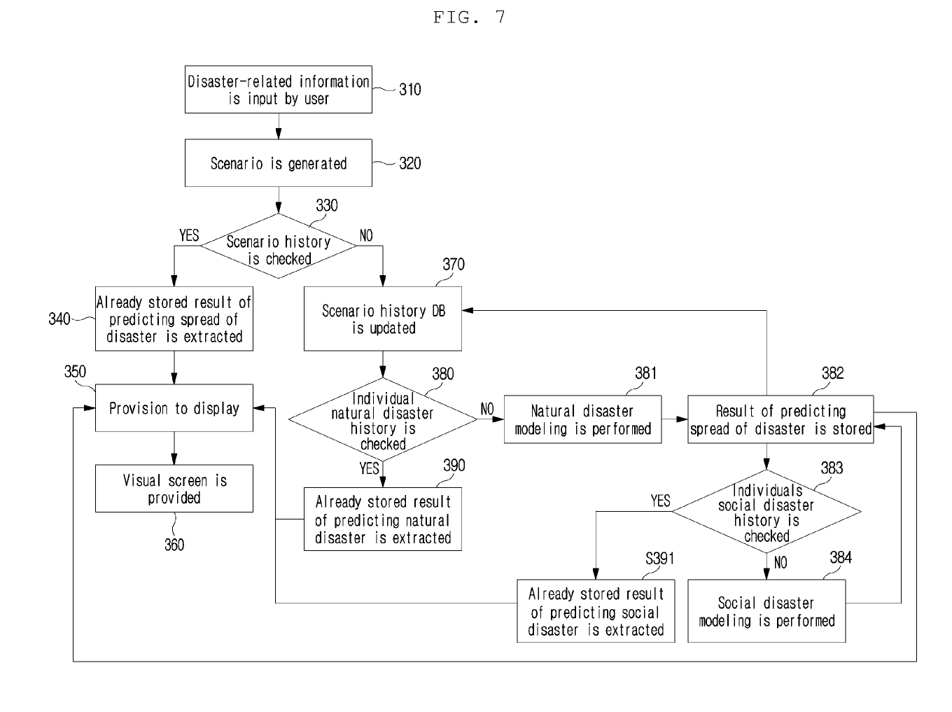

Also, at the generating of the connection scenario at step 220, at the performing of the individual-disaster modeling at step 230, and at the prediction of the spread of multiple disasters at step 240, a past history may be referenced. For example, the integrated modeling accelerator 130 may be used to check the existing scenario history and whether the individual-disaster modeling has been performed. Accordingly, it is possible that unnecessary repetitive processing of the same modeling is prevented and the longer the system is used, the faster the simulation result is provided to the user and the manager due to the accumulated modeling results. In this regard, a modeling method checking the past history and a technique of managing the databases will be described in detail with reference to FIGS. 7 to 9.

When the prediction of the spread of multiple disasters is completed, the result of the prediction is stored in the disaster spread prediction result database 150, and is provided to the manager/user as a visual screen via the display unit 163 in the visualization and external linkage unit 160. Here, the display unit 163 may include a speaker that outputs sound, and it is possible that a warning sound that varies according to the disaster situation or emergency level is provided to the manager/user.

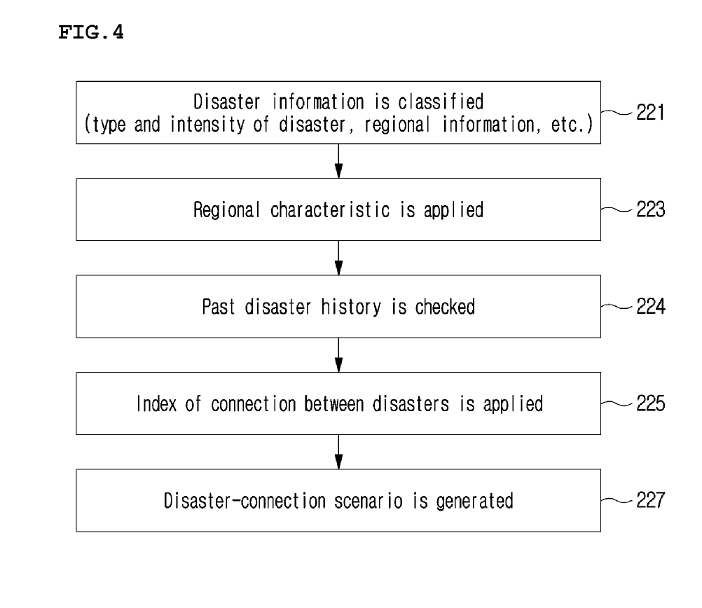

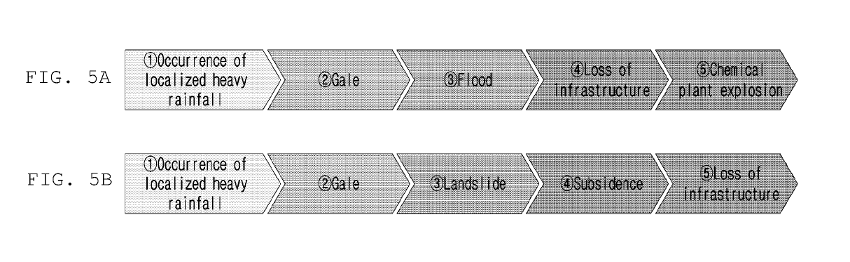

FIGS. 3 and 4 are flowcharts specifically illustrating automatic generation of a connection scenario at step 220 in the method of predicting the spread of multiple disasters according to the present disclosure. Also, FIGS. 5A and 5B are diagrams illustrating examples of connection scenarios of spread of multiple disasters, which are generated according to the present disclosure.

For example, when the manager or user intends to perform disaster prediction according to the regional characteristic for establishing disaster measures and for preventing disasters, the user inputs disaster-related information to be checked at step 210. Specifically, in the case where localized heavy rainfall occurs, when it is intended to check information on a disaster that may be connected to a situation which possibly occurs in a particular region (for example, Yuseong-gu, Daejeon, Republic of Korea), the name of the relevant region (for example, Yuseong-gu, Daejeon, Republic of Korea) is input as regional information and a predicted disaster situation (for example, heavy rain 100 ml per hour) is input as the disaster information. The apparatus or system 10 for predicting the spread of the disaster shown in FIG. 1 classifies the received disaster-related information according to the type of disaster, intensity of disaster, the regional information, and the like at step 221, information on the characteristic of the selected region according to the predicted disaster situation (for example, localized heavy rainfall) is checked at step 223, and the connection in which a disaster in the relevant region is caused by the localized heavy rainfall is calculated at step 225. Here, the connection of the disaster may be calculated on the basis of weightings using the regional characteristic, the disaster history, and the basic connection between individual disasters for application.

Here, the regional characteristics may include the size and composition of population, main facility information, industry information, livestock industry and agriculture utilization information, land utilization, and the like. Particularly, each regional characteristic may be digitized into a region coefficient and may be stored in the region coefficient database 180 for utilization. For example, 226 local autonomous regions nationwide may be classified into an urban-rural type, a large urban type, a small urban type, a park-city type, a small and medium urban type, and the like, and may be stored in a database for utilization.

By applying the regional characteristic and an index of connection between disasters, finally, the disaster-connection scenario is generated at step 227. The result of the generated disaster-connection scenario is stored in the scenario history database 170 shown in FIG. 1 for use.

Here, in generating the disaster-connection scenario, a history of disasters in the past may be further referenced. For example, as shown in FIG. 4, when the disaster information is classified and then the regional characteristic is applied, a process of checking the past disaster history in the relevant region related to the disaster information may be further included at step 224. For example, by checking the history of localized heavy rainfall occurred in the past in the particular region (for example, Yuseong-gu, Daejeon, Republic of Korea), a disaster-connection scenario most suitable for the regional characteristic is generated. However, considering the design operation method of the apparatus or system 10 for predicting the spread of multiple disasters of the present disclosure, it is possible that the process of checking the past disaster history at step 224 is omitted in generating the scenario but is applied in the individual-disaster modeling.

FIGS. 5A and 5B are diagrams illustrating examples of the disaster-connection scenarios 220 generated through the above-described process. FIG. 5A shows an example of the case where the disaster scenario is generated in the order of \textcircled{1} occurrence of localized heavy rainfall→\textcircled{2} gale→\textcircled{3} flood→\textcircled{4} loss of external infrastructure→\textcircled{5} chemical plant explosion. Specifically, when \textcircled{1} occurrence of localized heavy rainfall caused by a typhoon or hurricane is predicted, a multi-disaster connection scenario is generated in a predictive manner where a natural disaster caused by \textcircled{2} a gale, a natural disaster caused by \textcircled{3} flood, a social disaster caused by water pollution due to water purification facilities and inflow of wastewater (\textcircled{4} loss of social infrastructure), and a social disaster such as \textcircled{5} chemical plant explosion in the region in consequence of the natural disasters sequentially or independently occur thereafter.

Also, FIG. 5B shows an example of the case where the disaster scenario is generated in the order of \textcircled{1} occurrence of localized heavy rainfall→\textcircled{2} flood→\textcircled{3} landslide→\textcircled{4} subsidence→\textcircled{5} social disaster. Specifically, when \textcircled{1} occurrence of localized heavy rainfall is predicted, a multi-disaster connection scenario is generated where a natural disaster caused by \textcircled{2} flood due to the regional characteristic, a natural disaster caused by \textcircled{3} landslide according to the regional characteristic that classification into a landslide hazard region, a natural disaster caused by \textcircled{4} subsidence according to the regional characteristic of a road environment, and a social disaster such as loss of a railroad and a communication network in the region (\textcircled{5} loss of social infrastructure), and the like in consequence of the natural disasters sequentially or independently occur thereafter

In this regard, generally, after an individual natural disaster occurs, a social disaster occurs, but it is not limited thereto. Therefore, according to the interconnection between the natural disaster and the social disaster, the disaster-connection scenario may be generated either interdependently or independently.

FIG. 6 is a flowchart illustrating an example of performing individual-disaster modeling in the method of predicting the spread of multiple disasters according to the present disclosure.

First, as described in FIG. 1, after the disaster-connection scenario is generated at step 220, individual-disaster modeling in the scenario is performed at step 230. Here, the individual-disaster modeling is divided into natural disaster modeling at step 231 and social disaster modeling at step 235 and these may be performed in order or in parallel.

For example, among the individual disasters in the generated scenario, with respect to the disaster corresponding to the natural disaster, each natural disaster modeling is performed at step 231, and the result of the modeling is stored in the disaster spread prediction result database 150 as an individual disaster at step 233. Also, among the individual disasters in the generated scenario, with respect to the disaster corresponding to the social disaster, each social disaster modeling is performed at step 235, and the result of the modeling is stored in the disaster spread prediction result database 150 as an individual disaster 237. Here, the result of the modeling for predicting the spread of the disaster is stored in the database 150, and the history of the generated scenario is stored in the database 170.

That is, the disaster modeling is repeatedly performed in sequence or in parallel as much as the number of natural disasters and social disasters present in the generated disaster-connection scenario. Also, after the disaster modeling is performed at steps 231 and 235 and the result thereof is stored at steps 233 and 237 respectively, it is also possible that the results are directly visualized via the display unit 163 shown in FIG. 1. For example, the result of the modeling for prediction with respect to the individual disaster and information on the extent of damage based on a geographic information system (GIS), the degree of damage spread based on time series, the estimated amount of damage, and the like may be provided to the user. Here, the information to be provided may include information on the individual disaster as well as integrated information generated by the disaster-connection scenario.

FIG. 7 is a flowchart illustrating an example of a method of predicting a spread of multiple disasters by using a past scenario history and/or a past individual disaster history according to the present disclosure. Particularly, FIG. 7 shows in detail a method of checking whether there is a history when performing disaster modeling after the disaster-connection scenario is generated. Accordingly, by eliminating the repetitive performing of individual modeling for predicting the spread of the disaster, it is possible that the total time for predicting the spread of the disaster is reduced and the longer the system operates, the faster the spread of the disaster is predicted using the accumulated and stored results. This will be described in detail as follows.

First, when the user or manager inputs the disaster-related information to be predicted at step 310, the disaster-connection scenario is generated at step 320 through the process described with reference to FIGS. 2 to 5A and 5B. Next, before performing individual-disaster modeling, the scenario history is checked at step 330. That is, the scenario history DB 170 is searched to check whether the generated disaster-connection scenario has been previously performed. When the same disaster-connection scenario is present, the result is extracted from the disaster spread prediction result DB 150 at step 340, and the result is provided to the display unit 163 for visualization at step 350, and the visual screen is directly provided to the user at step 360. Accordingly, when the scenario history is present, it is possible that unnecessary repetition of the same operation is prevented and the processing time for checking the result is reduced. As the result of checking the scenario history at step 330, when the same disaster-connection scenario is not present, the scenario history DB 170 is updated with the generated disaster-connection scenario at step 370 for later utilization.

Also, before performing individual-disaster modeling, the disaster spread prediction result DB or disaster history DB is searched to check whether there is a disaster history in which individual-disaster modeling is the same even though the entire scenario is not the same. That is, before performing natural disaster modeling in stages, whether there is the same individual natural disaster history is checked at step 380. This is to shorten the processing time by using that not the same scenario is present but the same individual natural disaster history is present.

Here, as the result of step 380, when there is the same individual natural disaster previously stored, the result of prediction is extracted at step 390, the result is provided to the display unit 163 for visualization at step 350, and the visual screen is directly provided to the user at step 360. Accordingly, the processing time is reduced such that the result of prediction is provided to the user in real time.

In contrast, as the result of step 380, when there is no same individual natural disaster history, individual natural disaster modeling is performed at step 381, the result of individual-disaster modeling is stored at step 382, the result is provided to the display unit 163 for visualization at step 350, and the visual screen is provided to the user at step 360.

In the same manner, after checking the natural disaster history, information on the social disaster history is checked. That is, before performing social disaster modeling, whether there is the same individual social disaster history is checked at step 383. When there is the same individual social disaster previously stored, the result of prediction is extracted at step 391, the result is provided to the display unit 163 for visualization at step 350, and the visual screen is directly provided to the user at step 360. In contrast, as the result of step 383, when there is no same individual social disaster history, individual social disaster modeling is performed at step 384, the result of predicting the spread of the disaster is stored at step 382, the result is provided to the display unit 163 for visualization at step 350, and the visual screen is provided to the user at step 360.

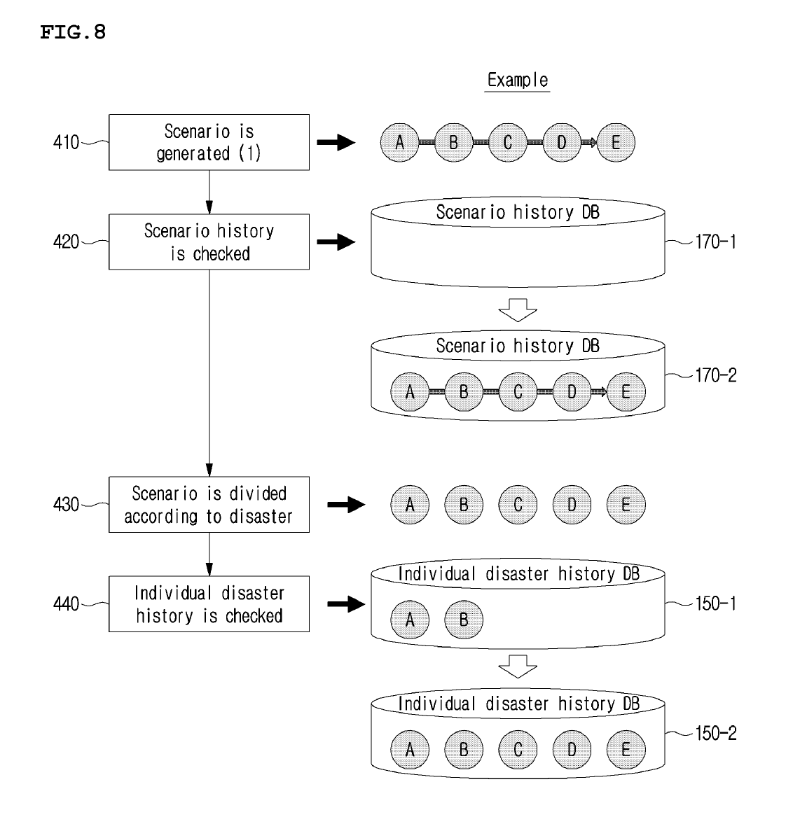

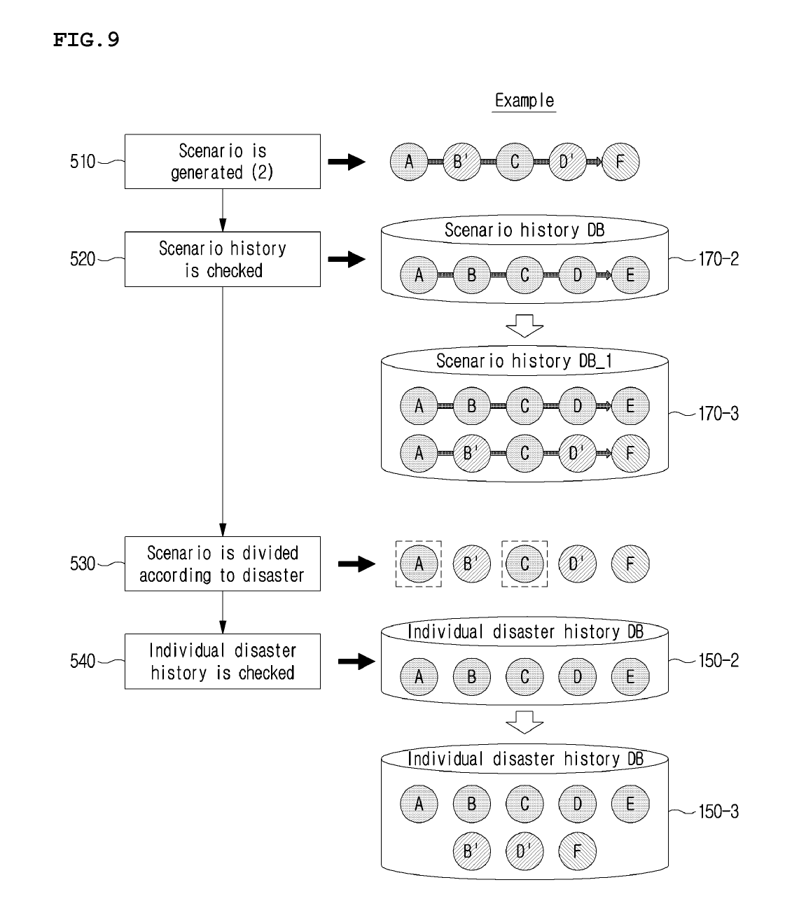

FIGS. 8 and 9 are diagrams illustrating examples of the method of predicting the spread of multiple disasters by using a process of checking the past scenario history and the individual disaster history and updating the databases according to the present disclosure. Particularly, as an illustrative example of the present disclosure, the process shown in FIG. 8 is performed, and then the process shown in FIG. 9 is performed.

Referring to FIG. 8, for example, when the disaster-connection scenario is generated as A→B→C→D→E at step 410, whether the scenario history of A→B→C→D→E is present already in the scenario history DB 170 is checked at step 420. When there is no scenario stored in the scenario history DB 170-1, the scenario history DB 170-2 is updated with the generated scenario A→B→C→D→E.

Next, the generated scenario is divided into histories A, B, C, D, and E of respective disasters at step 430, whether each individual disaster history is already present in the disaster spread prediction result DB or individual disaster history DB 150 is checked at step 440. When only individual disaster histories A and B are present in the individual disaster history DB 150-1, the individual disaster histories A and B are utilized. With respect to individual disaster histories C, D, and E, which are not present, individual-disaster modeling is performed, and then the individual disaster history DB 150-2 is updated with the result of modeling. Next, the individual disaster histories, which are modeled, are integrated such that the final result of predicting the spread of multiple disasters is generated and provided to the user.

FIG. 9 shows an example of the same process of predicting multiple disasters in the state in which the scenario history DB 170-2 and the individual disaster history DB 150-2 are updated by the process shown in FIG. 8.

Referring to FIG. 9, for example, when the disaster-connection scenario is generated as A→B′→C→D′→F at step 510, whether the scenario history of A→B′→C→D′→F is present in the scenario history DB 170-2 is checked at step 520. When only the scenario history of A→B→C→D→E is stored in the scenario history DB 170-2, the scenario history DB 170-3 is updated with the generated scenario A→B′→C→D′→F.

Next, the generated scenario is divided into histories A, B′, C, D′, and F of respective disasters at step 530, whether each individual disaster history is already present in the disaster spread prediction result DB or individual disaster history DB 150 is checked at step 540. Here, the individual disaster history B′ or D′ is not the same as the individual disaster history B or D but the similar individual disaster history.

When the individual disaster histories A, B, C, D, and E are already stored in the individual disaster history DB 150-2, the individual disaster histories A and C are extracted from the individual disaster history DB 150-2 and are intactly utilized. With respect to individual disaster histories B′, D′, and F, which are not stored in the individual disaster history DB 150-2, new modeling is performed, and then the individual disaster history DB 150-3 is updated with the result of modeling. Next, the individual disaster histories, which are modeled, are integrated such that the final result of predicting the spread of multiple disasters is generated and provided to the user.

As an alternative, according to the operation method of the apparatus or system 10 for predicting the spread of multiple disasters of the present disclosure, when similarity between individual disaster histories is determined and the similarity is extremely high, it is possible that new modeling is not performed with respect to the individual disaster history and the result of modeling already stored in the individual disaster history DB 150-2 is extracted and intactly utilized. For example, the individual disaster histories B and B′ and the individual disaster histories D and D′ are not identical but highly similar to each other. In this case, the modeling results B and D already stored in the individual disaster history DB 150-2 are utilized intactly or in a complement manner.

FIG. 10 is a diagram illustrating another use example of a system for predicting a spread of multiple disasters according to the present disclosure. Particularly, FIG. 10 shows the case where the user or the manager is located at remote places.

First, the apparatus or system 10 for predicting the spread of multiple disasters shown in FIG. 1 may correspond to a server 1100 for predicting multiple disasters shown in FIG. 10. As described above, the server 1100 for predicting multiple disasters may include at least the integrated multi-disaster modeling unit 100 and the connection scenario generating unit 140 shown in FIG. 1. In contrast, the storage unit having the above-described various databases 150, 170, and 180 and the visualization and external linkage unit 160 may be provided in the server 1100 or in other external organizations 1200, 1300, and 1400 and user terminals 1600 and 1700.

The user may execute a multi-disaster prediction application program (for example, a disaster prediction App) stored in the user terminals 1600 and 1700, and may input the disaster-related information so as to provide the disaster-related information to the server 1100 over a communication network 1500. Also, the user terminals 1600 and 1700 may receive output information related to various disasters, which includes the result of predicting the disaster, from the server 1100 over the communication network 1500. Also, the received information is provided to the user via display screens of the user terminals 1600 and 1700.

When the server 1100 for predicting multiple disasters receives the disaster-related information from the user, prediction of multiple disasters is performed and the result is stored using the flowcharts, which show prediction of multiple disasters, and the method of updating the databases described with reference to FIGS. 2 to 9. Also, the result of predicting multiple disasters, which includes the generated disaster-connection scenario and the result of disaster history modeling, is provided to other external organizations 1200, 1300, and 1400, such as a police station, a school, a fire station, and the like so as to prepare for the predicted disaster. Here, the generated disaster-connection scenario and the result of disaster history modeling may be directly stored in the server 1100, or may be stored in other external organizations for later utilization with request.

In the meantime, blocks that make up the apparatus or system for predicting the spread of multiple disasters are shown as individual blocks for convenience of description, but may be implemented in a single medium in which software is programmed. The programmed medium may include a ROM memory.

Although the present disclosure has been described above, it is understood by those skilled in the art which the present disclosure pertains to that the present disclosure may be variously substituted, varied, and modified without departing from the technical spirit and scope of the present disclosure, and is not limited to the above-described embodiments and the accompanying drawings.

What is claimed is:

1. A method of predicting a spread of a disaster using a scenario, the method comprising:
receiving disaster-related information;
generating a disaster-connection scenario by applying a regional characteristic and connection between disasters to the disaster-related information;
performing disaster modeling on each of the disasters that make up the disaster-connection scenario; and
predicting a spread of the multiple disasters by integrating results of the disaster modeling.

2. The method of claim 1, wherein the generating of the disaster-connection scenario comprises checking a past disaster scenario history.

3. The method of claim 1, wherein the performing of the disaster modeling comprises:
performing natural disaster modeling; and
performing social disaster modeling.

4. The method of claim 1, wherein the performing of the disaster modeling comprises checking a past history for each disaster.

5. The method of claim 1, further comprising:
storing a result of the generated disaster-connection scenario, a result of performing the disaster modeling, and a result of performing integrated multi-disaster modeling.

6. The method of claim 1, further comprising:
providing a result of predicting the spread of the multiple disasters as a visual screen.

7. An apparatus for predicting a spread of a disaster using a scenario, the apparatus comprising:
an information receiving unit receiving disaster-related information from a user;
a scenario generating unit generating a disaster-connection scenario by applying a regional characteristic and connection between disasters to the received disaster-related information;
an integrated multi-disaster modeling unit performing disaster modeling on each of the disasters that make up the disaster-connection scenario and predicting a spread of the multiple disasters by integrating results of the disaster modeling; and
a storage unit storing a result of predicting the spread of the multiple disasters.

8. The apparatus of claim 7, further comprising:
a display unit providing the result of predicting the spread of the multiple disasters as a visual screen.

9. The apparatus of claim 7, wherein the storage unit comprises:
a scenario history database (DB) storing a result of the disaster-connection scenario;
an individual disaster history database (DB) storing a history for each disaster; and
a disaster spread prediction result database (DB) the result of predicting the spread of the multiple disasters.

10. The apparatus of claim 7, wherein the storage unit comprises a region coefficient database (DB) storing the regional characteristic.

11. The apparatus of claim 7, wherein the information receiving unit comprises a user interface (UI) receiving the disaster-related information from the user.

12. The apparatus of claim 7, wherein the information receiving unit comprises a wireless communication unit receiving the disaster-related information from a remote user.

13. A system for predicting a spread of a disaster using a scenario, the system comprising:
a user terminal providing disaster-related information via a wired/wireless communication unit; and
a server for predicting multiple disasters, the server being configured to:
generate a disaster-connection scenario by applying a regional characteristic and connection between the disasters to the disaster-related information;
perform disaster modeling on each of the disasters that make up the disaster-connection scenario;
predict a spread of the multiple disasters by integrating results of the disaster modeling; and
transmit a result of prediction to the user terminal.

14. The system of claim 13, wherein the server for predicting the multiple disasters comprises a database therein, the database storing the disaster-connection scenario and the results of the disaster modeling that are generated by the server for predicting the multiple disasters.

15. The system of claim 13, wherein a database, which stores the disaster-connection scenario and the results of the disaster modeling that are generated by the server for predicting the multiple disasters, is provided in an external organization that is capable of wired/wireless communication with the server for predicting the multiple disasters.
